(19) United States
(12) Patent Application Publication
(10) Pub. No.: US 2015/0163549 A1
(43) Pub. Date: Jun. 11, 2015

(54) DISPLAY APPARATUS, USER TERMINAL DEVICE, SERVER, AND COMMUNICATING METHOD THEREOF

(71) Applicant: SAMSUNG ELECTRONICS CO., LTD., Suwon-si (KR)

(72) Inventors: Ji-woo SUH, Seoul (KR); Yong-hwan KWON, Seongnam-si (KR); Ji-hyae KIM, Seoul (KR)

(73) Assignee: SAMSUNG ELECTRONICS CO., LTD., Suwon-si (KR)

(21) Appl. No.: 14/336,381

(22) Filed: Jul. 21, 2014

(30) Foreign Application Priority Data
Dec. 10, 2013 (KR) 10-2013-0153164

(51) Int. Cl. H04N 21/475; H04N 21/462; H04N 21/222; H04N 21/258; H04N 21/4363; H04N 21/41

(52) U.S. Cl. CPC H04N 21/4753; H04N 21/43637; H04N 21/4126; H04N 21/2223; H04N 21/25816; H04N 21/4622

(57) ABSTRACT

A display apparatus includes a communicator, a display, and a controller configured to, in response to a user command to perform a connection with a user terminal device being input, control the communicator to receive a pin code from a server and control the display to display the pin code, and the controller is further configured to control the communicator to transmit, in response to a pin code consistent with the displayed pin code being input through the user terminal device, to the user terminal device through the server information on an Access Point (AP) where the display apparatus is connected.

### CROSS-REFERENCE TO RELATED APPLICATIONS

This application claims priority from Korean Patent Application No. 10-2013-0153164, filed in the Korean Intellectual Property Office on Dec. 10, 2013, the disclosure of which is incorporated herein by reference in its entirety.

### BACKGROUND

1. Field

Aspects of the exemplary embodiments relate to a display apparatus, a user terminal device, and a communicating method thereof, and more particularly, to a display apparatus which performs communication using a pin code, a user terminal device, and a communicating method thereof.

2. Description of the Related Art

An electronic apparatus using a technology such as Bluetooth and WiFi has been widely used. Recently, a WiFi Direct technology, a Digital Living Network Alliance (DLNA) are also applied to an electronic apparatus. In addition, various wireless technologies are applied to transmit and receive data quickly and accurately.

In order to use such various communication technologies between a display apparatus and an external electronic apparatus, a user needs to familiarize himself/herself with how to use the apparatuses, which may be inconvenient for the user. Conventionally, a pin code is provided on a display screen regardless of a communication technology, and when the same pin code is input to a user terminal device, the two devices are connected with each other.

However, if a display apparatus and a user terminal device do not use the same Access Point (AP), there is a limit to the speed or security when data is transmitted and received.

### SUMMARY

An aspect of the exemplary embodiments relates to a display apparatus which allows the display apparatus and a user terminal device to connect to the same AP in order to enhance a data transmission speed when communication is performed between the display apparatus and the user terminal device, a user terminal device, and a communicating method thereof.

A display apparatus according to an exemplary embodiment includes a communicator configured to communicate with a server and a user terminal device, a display, and a controller configured to, in response to a user command to perform a connection with a user terminal device being input, control the communicator to receive a pin code from the server and control the display to display the pin code, and the controller is further configured to control the communicator to transmit to the user terminal device through the server, in response to a pin code consistent with the displayed pin code being input through the user terminal device, information on an Access Point (AP) where the display apparatus connected.

The server, in response to a pin code consistent with the displayed pin code being input from the user terminal device, may transmit the information on the AP where the display apparatus is connected to the user terminal device.

The user command may be a command to select a menu for attempting a connection with a user terminal device provided on the screen.

The controller, in response to AP information received from the user terminal device being inconsistent with information on the AP where the display apparatus is connected, may set the AP of the user terminal device to be consistent with the AP of the display apparatus.

The controller may control to connect to the AP using WiFi.

A user terminal device according to an exemplary embodiment includes a display, a communicator configured to perform communication with a server, and a controller configured to transmit a pin code input to the server, and the controller, in response to the pin code transmitted to the server being consistent with a pin code displayed on a screen of a display apparatus, controls a connection to an AP which is a same as an AP of the display apparatus based on information on the AP where the display apparatus is connected.

The pin code may be input through a predetermined user interface (UI) screen, and the predetermined UI screen may be a UI screen which is provided through an application for a network connection with the server.

The controller, in response to the pin code transmitted to the server being consistent with the pin code displayed on a screen of a display, may control the display to display a UI screen for connection with the display apparatus based on information received from the server.

A communicating method of a display apparatus which performs a communication connection with a user terminal device according to an exemplary embodiment includes, in response to a user command to perform a connection with the user terminal device being input, receiving a pin code from a server and displaying the pin code, and in response to a pin code consistent with the displayed pin code being input through the user terminal device, transmitting information on an AP where the display apparatus is connected to the user terminal device through the server.

The server, in response to a pin code consistent with the display pin code being input from the user terminal device, may transmit information on the AP where the display apparatus is connected to the user terminal device.

The user command may be to select a menu to connect to a user terminal device, the menu being provided on the screen.

The method may further include, in response to AP information received from the user terminal device being inconsistent with information on the AP where the display apparatus is connected, setting the AP of the user terminal device to be consistent with the AP of the display apparatus.

The display apparatus may control to connect to the AP using WiFi.

A communicating method of a user terminal device which performs a communication connection with a display apparatus according to an exemplary embodiment, includes transmitting a pin code input to a server, and in response to the pin code transmitted to the server being consistent with a pin code displayed on a screen of the display apparatus, connecting to an AP which is a same as an AP of the display apparatus based on information on the AP where the display apparatus is connected, the information being transmitted from the server.

The pin code may be input through a predetermined user interface (UI) screen, and the predetermined UI screen may be a UI screen which is provided through an application for a network connection with the server.

The method may further include, in response to the pin code transmitted to the server being consistent with a pin code displayed on a screen of a display apparatus, displaying a UI screen for a connection with the display apparatus based on information provided from the server.

A non-transitory computer readable medium recording a program to perform a communicating method of a display apparatus which performs a communication connection with a user terminal device according to an exemplary embodiment includes, in response to a user command to perform a connection with the user terminal device being input, receiving a pin code from a server and displaying the pin code, and in response to a pin code consistent with the displayed pin code being input through the user terminal device, transmitting to the user terminal device through the server information on an AP where the display apparatus is connected.

A server according to an exemplary embodiment may include a communicator, and a controller configured to control the communicator to transmit a pin code to a first terminal device, and to connect, in response to receiving a pin code consistent with the transmitted pin code from a second terminal device, the first terminal device with the second terminal device.

The controller may be further configured to control the communicator to transmit to the second terminal device information on an Access Point (AP) to which the first terminal device is connected. The transmission may be in response to receiving a pin code consistent with the transmitted pin code from a second terminal device.

A communication connection method of a first terminal device and a second terminal device according to an exemplary embodiment may include: in response to a user command received by the first terminal to perform communication connection with the second terminal, receiving by the first terminal a pin code from a server; transmitting by the second terminal device a pin code consistent with the received pin code to the server; and connecting the first terminal device with the second terminal device through the server.

The connecting of the communication connection method may include transmitting by the server to the second terminal device an Access Point (AP) information regarding an AP where the first terminal device is connected, and connecting the second terminal apparatus to the AP using the AP information.

As described above, according to an exemplary embodiment, as a display apparatus and a user terminal device communicate with each other using the same AP, a data transmission speed between apparatuses can be improved.

### BRIEF DESCRIPTION OF THE DRAWINGS

The above and/or other aspects of certain exemplary embodiments will be more apparent with reference to the accompanying drawings, in which:

FIG. 1 is a view illustrating a communication system to which one or more exemplary embodiments may be applied;

FIG. 2 is a block diagram illustrating a display apparatus and a user terminal device according to an exemplary embodiment;

FIGS. 3 to 6 are views illustrating an operation process of a display apparatus and a user terminal device according to an exemplary embodiment;

FIG. 7 is a view illustrating a UI screen of a display apparatus when a plurality of external user terminal devices are connected to the display apparatus; and

FIG. 8 is a flowchart illustrating a method of device connection according to an exemplary embodiment.

### DETAILED DESCRIPTION

It should be observed the method steps and system components have been represented by conventional symbols in the figure, showing only specific details which are relevant for an understanding of the exemplary embodiments. Further, additional details may be apparent to a person ordinarily skilled in the art or may become apparent through the practice of one or more exemplary embodiments. As used herein, relational terms such as first and second, and the like, may be used to distinguish one entity from another entity, without necessarily implying any actual relationship or order between such entities.

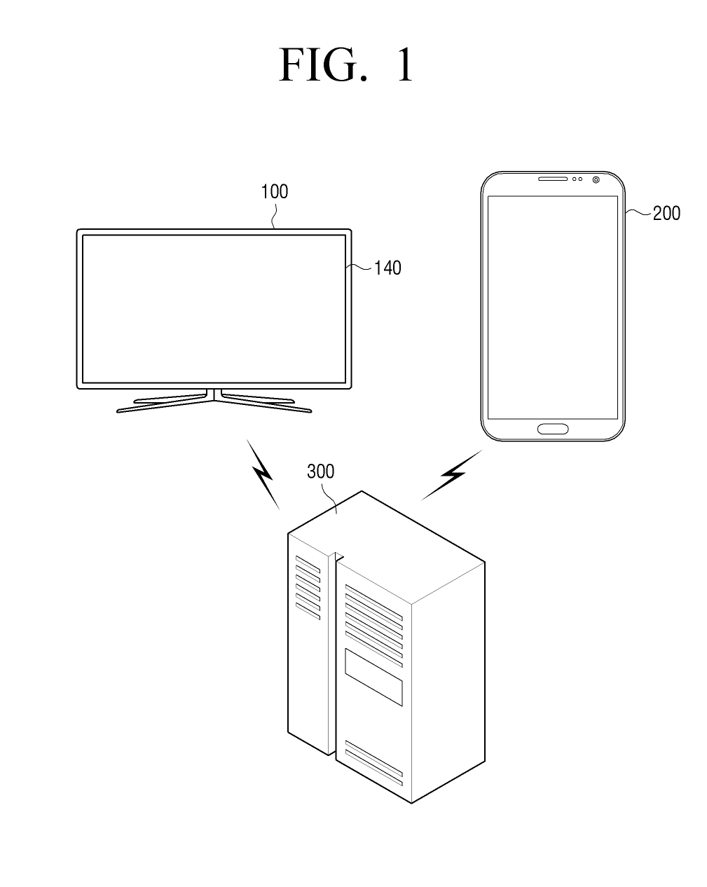

FIG. 1 is a view illustrating a communication system to which one or more exemplary embodiments may be applied. As illustrated in FIG. 1, a communication system consists of a digital television (DTV) 100 which is a kind of broadcast receiver, a user terminal device 200, and a server 300. However, this is merely an example, and one or more exemplary embodiments may be applied to different systems.

The DTV 100 displays a broadcast received through a broadcasting medium on a display 140 to provide the broadcast to a user. In addition, the DTV 100 may display a web page received through Internet on the display 140 to provide the web page to a user. The user terminal device 200 may be realized as a smart phone, but may be any electronic apparatus which can be connected wirelessly.

Briefly describing an operation process, the server 300 stores a pin code, and transmits the pin code to the DTV 100 in response to a pin code request from the DTV 100. The DTV 100 displays the pin code transmitted from the server 300. In this case, the user terminal device 200 launches an application capable of performing network connection with the server 300, and inputs and transmits the pin code displayed on the DTV 100 to the server 300. The server 300 compares the pin code input from the user terminal device 200 with the pin code provided to the DTV 100, and, if the two pin codes are consistent with each other, the DTV 100 and the user terminal device 200 are connected with each other. Although a DTV 100 is described, a user terminal may connect to a different device, such as, as a non-limiting example, a computer.

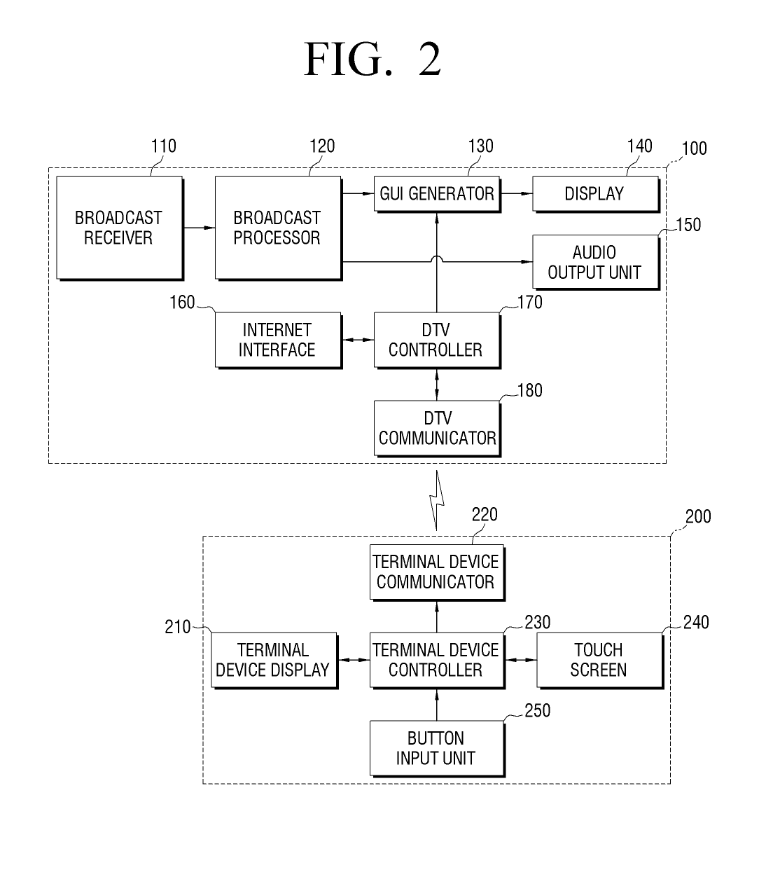

Hereinafter, the DTV 100 and the user terminal device 200 will be described in with reference to FIG. 2. FIG. 2 is a block diagram illustrating the DTV 100 and the user terminal device 200 according to an exemplary embodiment.

As illustrated in FIG. 2, the user terminal device 200 includes a terminal device display 210, a terminal device communicator 220, a terminal device controller 230, a touch screen 240, and a button input unit 250.

The terminal device display 210 displays a GUI.

The terminal device communicator 220 may be connected with the DTV 100 or a server, which will be described later, using wireless communication. The terminal device communicator 220 may be connected directly with the DTV 100 using Bluetooth, WiFi, etc.

The button input unit 250 provides various buttons where a user command is input through a press manipulation by a user.

The touch screen 240 is functioned as a display where a screen is displayed, and may also be functioned as a user input means to receive a touch manipulation. A button input may also be performed through a button formed on the touch screen 240.

Meanwhile, a server (not shown) may store a high-capacity pin code, and transmits the pin code to the DTV 100 in response to a request from the DTV 100. The transmitted pin code is shown to a user through the display 140 of the DTV 100. If the user launches an application capable of connecting to the server (not shown) on the user terminal device 200 via a network and inputs the pin code, the corresponding pin code is transmitted to the server (not shown).

The terminal device controller 230 may control the terminal device communicator 220 to transmit the input pin code to the server 300 through a UI screen. The UI screen may be a predetermined UI screen. The terminal device controller 230 receives the pin code through the button input unit 250 or the touch screen 240 and transmits the corresponding pin code to the server (not shown). The server compares the pin code provided to the DTV 100 with the pin code received from the user terminal device 200.

Herein, the predetermined UI screen is provided through an application for network connection with the server 300. In addition, the application for network connection with the server 300 is designed for a user who uses the DTV 100 and the user terminal device 200. If the above-described application for network connection with the server 300 is installed in the user terminal device 200, a user may perform communication between the DTV 100 and the user terminal device 200 only with an operation of inputting a pin code. When performing communication between apparatuses which support a specific communication method such as WiFi, Bluetooth, and DLNA, a user may perform the communication even if he or she does not know the specific communicating method.

If the pin code transmitted to the server 300 and the pin code displayed on the screen of the DTV are consistent with each other, the terminal device controller 230 may control to connect to the same access point (AP) as the DTV based on the information on the AP where the DTV is to be connected, which is received from the server 300.

If the pin code transmitted to the server 300 and the pin code displayed on the screen of the DTV are consistent with each other, the terminal device controller 230 may display a UI screen for connection with the DTV 100 based on the information received from the server 300. Herein, the UI screen includes information on the AP where the DTV 100 is to be connected, and the user terminal device 200 may be connected to the AP where the DTV 100 is to be connected in response to a button (for example, a connection button) on the UI screen being selected.

If the DTV 100 and the user terminal device 200 use the same AP, a data transmission speed may be further improved, and security may be more strengthened than in the case where the DTV 100 and the user terminal device 200 are connected to different APs.

The DTV 100 and the user terminal device 200 may perform wireless communication using WiFi, and the DTV 100 and the user terminal device 200 may perform communication using DLNA.

Herein, the server 300 is formed separately from the DTV 100, but this is only an example. The DTV 100 may include the function of the server 300. In this case, the DTV 100 may store a high-capacity pin code, and if an application of the user terminal device 200, which is capable of performing a network connection, is launched and the pin code displayed on the DTV 100 is input, the DTV 100 receives the corresponding pin code, and the DTV 100 and the user terminal device 200 may perform a wireless communication connection.

If the DTV 100 and the user terminal device 200 are connected by using the server 300, the terminal device controller 230 transmits information regarding a button pressed by a user through the button input unit 250 to the DTV 100 through the terminal device communicator 220. The terminal device controller 230 displays a screen transmitted from the DTV 100 on the touch screen 230.

Meanwhile, as illustrated in FIG. 2, the DTV 100 includes a broadcast receiver 110, a broadcast processor 120, a GUI generator 130, a display 140, an audio output unit 150, an Internet interface 160, a DTV controller 170, and a DTV communicator 180.

The DTV 100 displays a broadcast which is received through a broadcasting medium on the display 140 and provides the broadcast to a user.

The broadcast receiver 110 receives a broadcast from a broadcasting station or a satellite over a wired connection or wirelessly and demodulates the broadcast.

The broadcast processor 120 performs signal processing with respect to a broadcast output from the broadcast receiver 110, such as video decoding, video scaling, audio decoding, etc. The broadcast processor 120 transmits an image signal to the GUI generator 130 and transmits an audio signal to the audio output unit 150, respectively.

The GUI generator 130 generates a GUI to be displayed on the display 140, and adds the generated GUI to an image output from the broadcast processor 120.

The display 140 displays an image where the GUI output from the GUI generator 130 is added.

The audio output unit 150 outputs an audio output from the broadcast processor 120 through a speaker.

A remote controller (not shown) transmits a user manipulation to the DTV 100, and the DTV 100 performs an operation in accordance with the user manipulation. The remote controller (not shown) may include a touch screen.

The Internet interface 160 is connected for communication via the Internet and receives a web page from a web server on Internet.

The DTV communicator 180 may perform communication with the server 300 and the user terminal device 200.

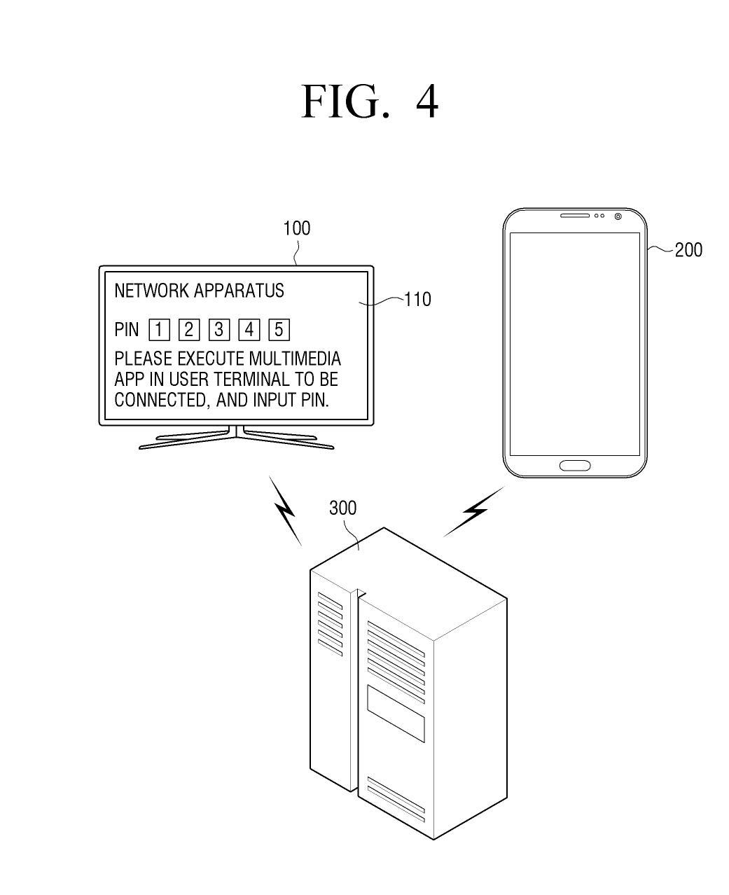

In response to a user command to connect to an external apparatus including the user terminal device 200 is input, the DTV controller 170 may control the DTV communicator to receive a pin code from the server 300 and display the pin code on the display 140, which will be described in detail with reference to FIG. 4.

If a pin code which is consistent with the pin code displayed on the DTV controller 170 is input through the user terminal device 200, the DTV controller 170 may control to transmit information on the AP where the DTV is connected to the user terminal device 200 through the server 300.

Herein, if the pin code which is consistent with the displayed pin code is received through the user terminal device, the server 300 may transmit the information on the AP where the DTV 100 is connected to the user terminal device 200.

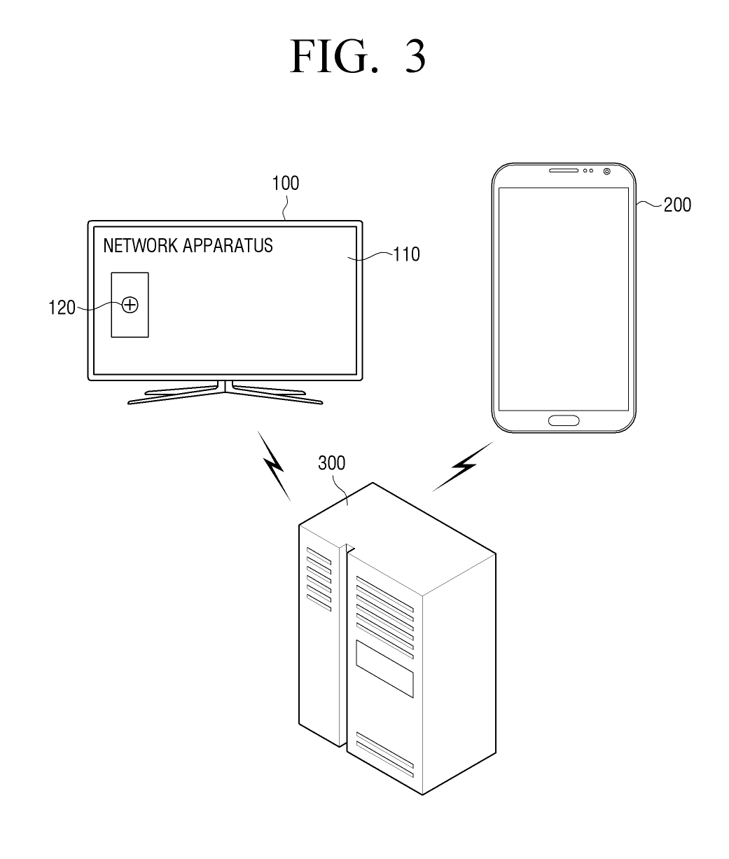

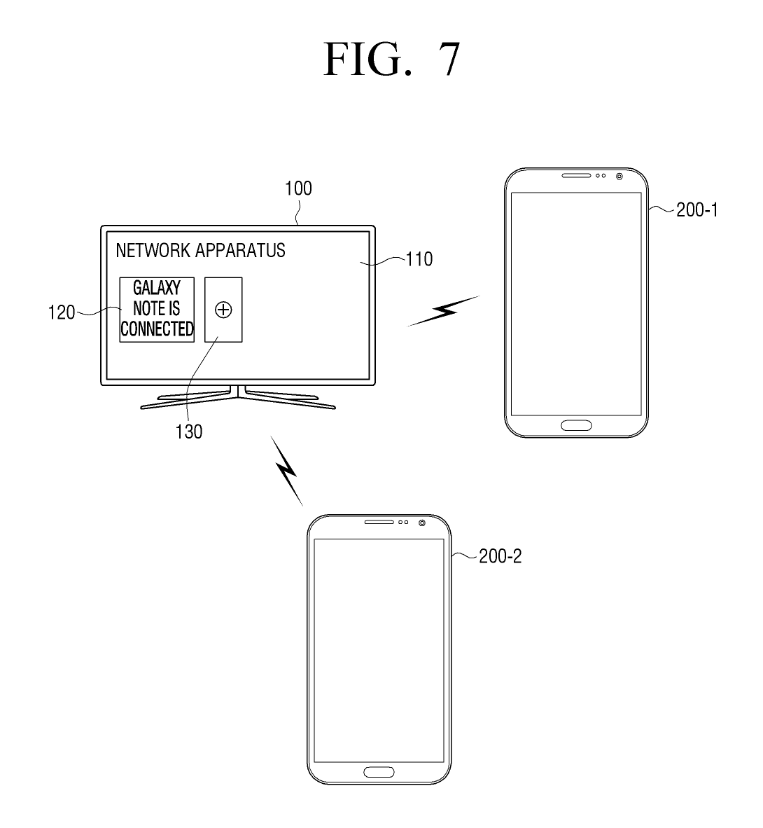

The user command provided on the screen of the display 140 may be a command to select the user terminal device 200. The user command may consist of buttons provided on the UI screen, which will be described in detail with reference to FIG. 3 and FIG. 7.

If the AP information which the server 300 receives from the user terminal device 200 is not consistent with the information on the AP where the DTV 100 is connected, the DTV controller 170 may set the AP of the user terminal device 200 to be consistent with the AP of the DTV 100.

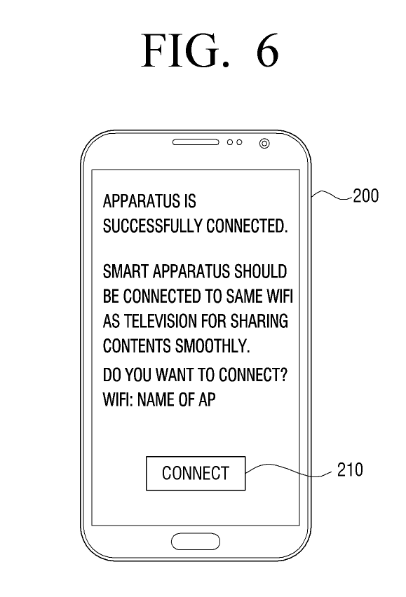

Herein, the pin number of the AP that the user terminal device 200 uses is pre-stored in the DTV 100 and thus, the user terminal device 200 may use the same AP as the DTV 100. In this case, the DTV 100 may provide the AP information as illustrated in FIG. 6 to the user terminal device 200 so that the user terminal device 200 sets the AP where the DTV is connected, but if the user terminal device 200 is preset to be connected to the DTV 100, the DTV 170 may set the AP of the user terminal device 200 automatically.

FIGS. 3 to 6 are views illustrating an operation process of a DTV and a user terminal device according to an exemplary embodiment.

According to FIG. 3, the DTV 100 may provide a UI screen 110 to perform a connection with an external apparatus. The UI screen 110 for performing a connection with an external apparatus is configured consistently. A user may receive a pin code from an external server 300 and display the pin code on the UI screen 110 with a simply operation of selecting a menu 120 on the UI screen 110, and if the user terminal device 200 inputs the pin code, communication between the DTV 100 and the user terminal device 200 may be performed through the server 300. That is, a communication connection with the external user terminal device 200 may be performed by selecting the menu 120 on the display 140 of the DTV 100.

Specifically, a user may select ‘+’ button on the menu 120 of the DTV. The user may select ‘+’ button using a user touch or a button/touch provided on a remote controller (not shown). If ‘+’ button is selected, the DTV 100 requests a pin code from the server 300 through the DTV communicator 180. The server 300 transmits the pin code to the DTV 100 in response to a request from the DTV 100. In this case, the server 300 may include a process of authenticating the DTV 100.

Referring to FIG. 4, the DTV 100 may receive a pin code from the server 300 and display the pin code on the screen of the display 140. In this case, the DTV 100 may receive a connection attempt of the user terminal device 200 and whether the connection attempt is succeeded from the server 300.

In addition, the DTV 100 includes a timer with an alarm function, and if a pin code corresponding to the pin code displayed on the display 140 is not transmitted from the server 300 within a predetermined time, the screen of FIG. 3, that is, the screen for setting a network connection with the external user terminal device 200 may be displayed again.

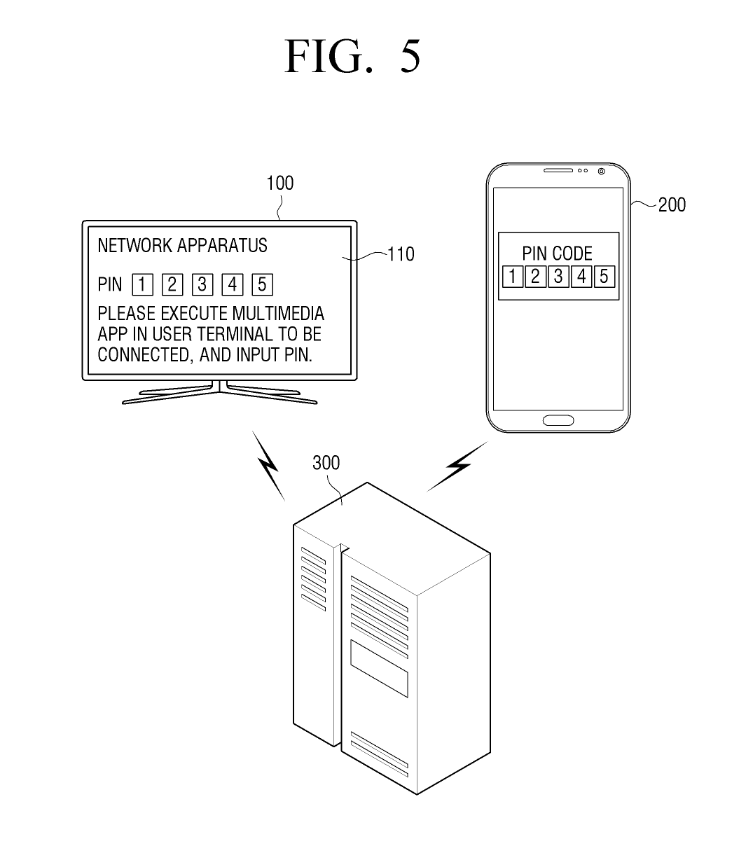

Referring to FIG. 5, a user of the user terminal device 200 checks a pin code on the screen of the DTV 100 as illustrated in FIG. 4, and launches an application for a network connection with the server 300. The application for a network connection with the server 300 may be an application for using a DLNA communication method. After the application is launched, the user inputs the corresponding pin code into the user terminal device 200. The user terminal device 200 transmits the input pin code to the server 300. The server 300 determines whether the pin code received from the user terminal device 200 is consistent with the pin code transmitted to the DTV 100, and, if the two pin codes are consistent with each other, may transmit information regarding connection success between the two apparatuses to the user terminal device 200 and the DTV 100. Subsequently, the DTV 100 and the user terminal device 200 may transmit and receive data including multimedia through the server 300, and the DTV 100 and the user terminal device 200 may even communicate directly with each other without going through the server 300. In the exemplary embodiment, the DTV 100 and the user terminal device 200 performs communication using the server 300, but direction communication, such as tethering using Bluetooth, can also be performed.

According to FIG. 6, if communication is performed between the DTV 100 which is connected to the AP using WiFi and the user terminal device 200 through the server 300, the DTV 100 and the user terminal device 200 may be connected to different APs.

In this case, if the DTV 100 and the user terminal device 200 are connected to the same AP, there are advantages in data transmission and security and thus, the server 300 may transmit the AP information of the DTV 100 to the user terminal device 200. The user terminal device 200 may provide the received AP information to a user through a UI screen. The UI screen including the AP information further provides a ‘connect’ button, and, if the button is pressed by a user, the user terminal device 200 attempts to connect to the same AP as the DTV 100. If the DTV 100 and the user terminal device 200 are connected to the same AP, data transmission can be performed easily.

FIG. 7 is a view illustrating a UI screen of a DTV when a plurality of external apparatuses are connected to the DTV. A user who is watching the DTV 100 is connected to an external user terminal device 200-1. ‘Galaxy Note is Connected’ 120 at the left center of the UI screen 100 indicates the type of apparatus of the user terminal device 200-1 and indicates that it is connected. By pressing ‘+ button’ menu 130, the DTV 100 may be connected to another external terminal device 200-2 using the same method as described in FIGS. 3 to 6.

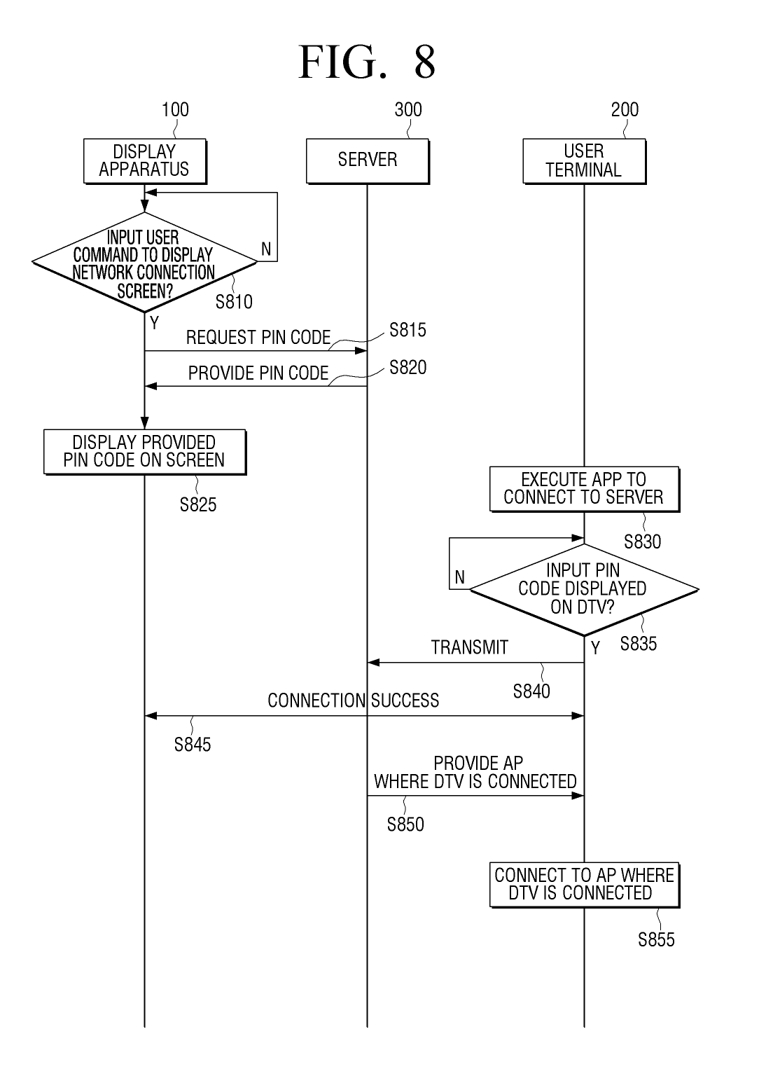

FIG. 8 is a flowchart illustrating a method of device connection according to an exemplary embodiment.

In the flowchart of FIG. 8, 1) the steps on the left side are performed by the DTV 100, 2) the steps on the right side are performed by the user terminal device 200, 3) the server 300 is disposed at the center, and 4) transmitting and receiving commands, messages, data or information between the DTV, the server 300, and the user terminal device is described.

According to FIG. 8, the DTV 100 may provide a communication connection with respect to the user terminal device 200.

First of all, the DTV 100 displays a network connection UI screen to perform communication with the user terminal device 200 and the server 300. In this case, if a user command is input (S810), a pin code is requested from the server 300 (S815). The server 300 may provide the pin code to the DTV 100 in response to the request (S820). Herein, the user command may be to select a menu provided on the screen of the DTV 100.

Subsequently, the DTV 100 displays the pin code provided from the server 300 on the screen (S825). The DTV 100 may wait unit there is a feedback from the server 300. In this case, if there is no feedback from the server 300 for a predetermined time, which is measured using a timer, a user command can be expected again, as described above.

The user terminal device 200 executes an application to perform a connection with the server 300 (S830). If the user terminal device 200 does not have a corresponding application, the server 300 may recommend an app store where the corresponding application is provided. Although in the flowchart S830 occurs after S825, S830 may occur before any of the previous steps.

If the pin code displayed on the DTV 100 is input in the user terminal device 200 by a user (S835), the corresponding pin code is transmitted to the server 300 through a communicator of the user terminal device 200 (S840).

The server 300 compares the pin code received from the user terminal device 200 with the pin code provided to the DTV 100, and if the two pin codes are consistent with each other, the server 300 may inform the DTV 100 and the user terminal device 200 that the connection is a success (S845). Additionally, the server 300 may transmit information on the AP where the DTV 100 is connected to the user terminal device (S850). In the above exemplary embodiment, the server 300 transmits the AP information to the user terminal device 200, but the DTV may also transmit the AP information to the user terminal device 200. In addition, in the above exemplary embodiment, the server 300 and the DTV 100 are described as separate apparatuses from each other, but the DTV 100 may have the function of the server 300.

The user terminal device 200 may connect to the AP of the DTV 100 using the AP information of the DTV 100 (S855). As the operation of providing AP information and performing a connection has already been described above, further description will not be provided.

If the AP information received from the user terminal device 200 is not consistent with the information on the AP where the DTV 100 is connected, the step of setting the AP of the user terminal device 200 to be consistent with the AP of the DTV may be further included. In this case, an agreement to set the AP of the user terminal device 200 in advance may be required.

Meanwhile, a program to perform a communicating method of a DTV which performs a communication connection with a user terminal device may be stored in a non-transitory computer readable medium.

Specifically, a non-transitory computer readable medium storing a program regarding a communicating method which includes the step of, if a user command to perform a connection with a user terminal device is input, receiving a pin code from the server 300 and displaying the pin code, and if a pin code consistent with the displayed pin code is input through the user terminal device, transmitting information on the AP where a DTV is connected to the user terminal device through the server may be provided.

The non-transitory computer readable medium refers to a medium which may store data semi-permanently rather than storing data for a short time such as a register, a cache, and a memory and may be readable by an apparatus. Specifically, the above-described various applications or programs may be stored in a non-temporal recordable medium such as CD, DVD, hard disk, Blu-ray disk, USB, memory card, ROM, etc. and provided therein.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A display apparatus comprising:
a communicator configured to communicate with a server and a user terminal device;
a display; and
a controller configured to, in response to a user command to perform a connection with a user terminal device being input, control the communicator to receive a pin code from the server and control the display to display the pin code,
wherein the controller is further configured to control the communicator to transmit, in response to a pin code consistent with the displayed pin code being input through the user terminal device, to the user terminal device through the server information on an Access Point (AP) where the display apparatus is connected.

2. The apparatus as claimed in claim 1, wherein the server, in response to a pin code consistent with the displayed pin code being input through the user terminal device, is configured to transmit the information on the AP where the display apparatus is connected to the user terminal device.

3. The apparatus as claimed in claim 1, wherein the user command comprises a command to select a menu for attempting a connection with a user terminal device provided on the display.

4. The apparatus as claimed in claim 1, wherein the controller, in response to AP information received from the user terminal device being inconsistent with information on the AP where the display apparatus is connected, is further configured to control the AP of the user terminal device to be set to be consistent with the AP of the display apparatus.

5. The apparatus as claimed in claim 1, wherein the controller is further configured to control a connection to the AP using WiFi.

6. A user terminal device comprising:
a display;
a communicator configured to perform communication with a server; and
a controller configured to transmit a pin code to the server,
wherein the controller, in response to the pin code transmitted to the server being consistent with a pin code displayed on a screen of a display apparatus, is further configured to control a connection to an access point (AP) that is the same as an AP of the display apparatus based on information of the AP to which the display apparatus is connected.

7. The device as claimed in claim 6, wherein the pin code is input through a predetermined user interface (UI) screen, and wherein the predetermined UI screen is provided through an application for connection with the server.

8. The device as claimed in claim 6, wherein the controller, in response to the pin code transmitted to the server being consistent with the pin code displayed on the screen of the display apparatus, is further configured to control the display to display a UI screen for connection with the display apparatus based on information received from the server.

9. A communicating method of a display apparatus configured to perform a communication connection with a user terminal device, the method comprising:
in response to a user command to perform a connection with the user terminal device being input, receiving a pin code from a server and displaying the pin code; and
in response to a pin code consistent with the displayed pin code being input through the user terminal device, transmitting to the user terminal device through the server information on an Access Point (AP) where the display apparatus is connected.

10. The method as claimed in claim 9, wherein the server, in response to the pin code input from the user terminal device being consistent with the displayed pin code, transmits to the user terminal device information on the AP where the display apparatus is connected.

11. The method as claimed in claim 9, wherein the user command comprises selecting a menu to connect to a user terminal device, the menu being provided on the screen.

12. The method as claimed in claim 9, further comprising:
in response to information of an AP of the user terminal device being inconsistent with information on the AP where the display apparatus is connected, setting the AP of the user terminal device to be consistent with the AP of the display apparatus.

13. The method as claimed in claim 9, wherein the display apparatus is connected to the AP using WiFi.

14. A communicating method of a user terminal device configured to perform a communication connection with a display apparatus, the method comprising:
transmitting a pin code input to a server; and
in response to the pin code transmitted to the server being consistent with a pin code displayed on a screen of the display apparatus, connecting to an Access Point (AP) that is the same as an AP where the display apparatus is connected based on information on the AP where the display apparatus is connected, the information being transmitted from the server.

15. The method as claimed in claim 14, wherein the pin code is input through a predetermined user interface (UI) screen, and wherein the predetermined UI screen is a UI screen provided through an application for connection with the server.

16. The method as claimed in claim 14, further comprising:
in response to the transmitted pin code being consistent with the pin code displayed on the screen of the display apparatus, displaying a UI screen for connection with the display apparatus based on information received from the server.

17. A non-transitory computer readable medium having stored thereon a program to perform a communicating method of a display apparatus configured to perform a communication connection with a user terminal device, the method comprising:
in response to a user command to perform a connection with the user terminal device being input, receiving a pin code from a server and displaying the pin code; and
in response to a pin code consistent with the displayed pin code being input through the user terminal device, transmitting to the user terminal device through the server information on an Access Point (AP) where the display apparatus is connected.

18. A server comprising:
a communicator; and
a controller configured to control the communicator to transmit a pin code to a first terminal device, and to connect, in response to receiving a pin code consistent with the transmitted pin code from a second terminal device, the first terminal device with the second terminal device.

19. The server of claim 18, wherein, in response to receiving a pin code consistent with the transmitted pin code from a second terminal device, the controller is further configured to control the communicator to transmit to the second terminal device information on an Access Point (AP) to which the first terminal device is connected.

20. A communication connection method of a first terminal device and a second terminal device, the method comprising:
in response to a user command received by the first terminal to perform communication connection with the second terminal, receiving by the first terminal a pin code from a server;
transmitting by the second terminal device a pin code consistent with the received pin code to the server; and
connecting the first terminal device with the second terminal device through the server.

21. The communication connection method of claim 20, wherein the connecting comprises transmitting by the server to the second terminal device an Access Point (AP) information regarding an AP where the first terminal device is connected, and connecting the second terminal apparatus to the AP using the AP information.
